(19) United States
(12) Patent Application Publication
(10) Pub. No.: US 2004/0085774 A1
(43) Pub. Date: May 6, 2004

(54) Candle Lamp holder

(76) Inventor: Yuan-Shun Hsu, Hsin-Chu Hsien (TW)

Correspondence Address: BIRCH STEWART KOLASCH & BIRCH, PO BOX 747, FALLS CHURCH, VA, 22040-0747, US

(21) Appl. No.: 10/288,496

(22) Filed: Nov. 6, 2002

(51) Int. Cl. F21V 21/00

(52) U.S. Cl. 362/392; 362/396; 362/810

(57) ABSTRACT

A candle lamp holder includes a lighting element and a holder. The holder has an upper end formed an inclined surface to hold the lighting element. The inclined surface enables the candle lamp to generate desired sensuous visual effect and three-dimensional lighting images when the candle lamp is energized with electricity to increase the added value of the candle lamp holder.

### FIELD OF THE INVENTION

The present invention relates to an improved candle lamp holder that imitates a candle profile to foster warm and soothing atmosphere for houses and living quarters.

### BACKGROUND OF THE INVENTION

It is a common practice these days to decorate wedding parties, celebration events, dinner parties, dancing parties and the like with ornamental lights of different colors to foster joyful atmosphere and generate amusing and entertaining effect.

Some of the ornamental lights are candle lamps that imitate candle profiles. FIG. 1 illustrates one of such examples that has a cylindrical holder 1. The holder 1 has a horizontal holding surface 21 for holding a flame-shaped lighting element 22 in the center thereof. When energized with electricity, the lighting element 22 emits light to help creating colorful illumination to decorate the sites of wedding parties, celebration events, dinner parties, dancing parties or living quarters.

While conventional candle lamps mentioned above can help to create pleasant atmosphere in the wedding parties, celebration events, dancing parties or living quarters, the holding surface 21 is always horizontal. The design lacks three dimensional touch or real sense. Moreover, the lighting element 22 mostly is bare lighting bulb with plain surface. The colorful and amusing lighting effect is mainly produced through decorative articles shrouding the candle lamp. Hence the lighting element 22 does not add much sensuous effect by itself. Its lack of three-dimensional effect and little versatility to mate the total environment does not give much delight to users. And its effectiveness to foster soothing and warm atmosphere is limited.

### SUMMARY OF THE INVENTION

Therefore the primary object of the invention is to resolve the foregoing disadvantages. The invention provides an improved candle lamp holder to give the candle lamp a three dimensional sense and a more appealing visual effect.

In order to achieve the foregoing object, the candle lamp holder of the invention includes a lighting element and a holder. The holder has one end formed an inclined surface to hold the lighting element. When energized with electricity, the candle lamp can generate a three dimensional visual effect and provide more sensuously pleasant lighting results, thus offer greater added value for the holder.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional candle lamp.

FIG. 2 is a perspective view of the invention.

FIG. 3 is an exploded view of the invention.

FIG. 4 is a schematic view of a first embodiment of the invention.

FIG. 5 is a schematic view of a second embodiment of the invention.

FIG. 6 is a schematic view of a third embodiment of the invention.

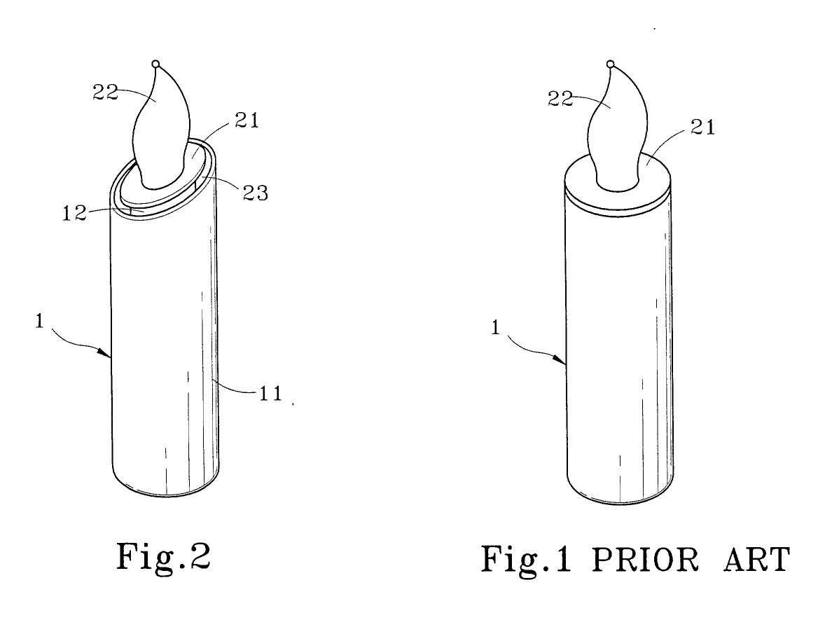

### DETAILED DESCRIPTION OF THE PREFERRED EMBODIMENTS

Referring to FIG. 2, the candle lamp holder of the invention mainly includes a lighting element 22 and a holder 1. The holder has an upper end forming an inclined surface 21 to hold the lighting element 22. When energized with electricity, the inclined surface 21 enables the entire candle lamp to generate a three dimensional visual effect and provide more sensuously pleasant lighting results, thus offer greater added value for the holder.

The holder 1 is made from melt-resistant or heat-resistant materials.

The lighting element 22 is a light emitting diode or a lighting bulb.

The inclined surface 21 is wider than the holding surface of conventional candle lamps to enable the lighting element 22 to reflect more effectively and repeatedly to generate scattering lights and to project into people's left eye and right eye to form overlapping and three dimensional images through parallax principle. Therefore users may see more brilliant and higher quality three-dimensional images and experience more joyful visual effects. The inclined surface 21 and the lighting element 22 may be integrally formed or made separately.

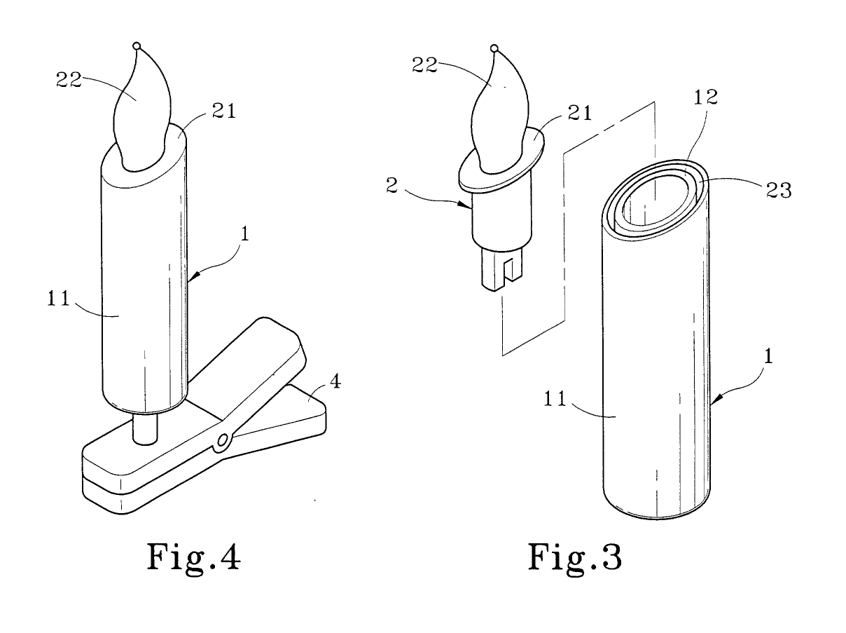

Referring to FIG. 3, the holder 1 of the invention includes an outer shell 11 and an inner shell 12 which is fixedly located inside the outer shell 11. The upper end of the inner shell 12 engages with a coupling unit 2 which is extended downwards from the inclined surface 21. The coupling unit 2 has an upper side engaging with a lighting element 22. When the lighting element 22 on the inclined surface 21 is energized, it can generate a three dimensional visual effect and provide more sensuously pleasant lighting results. Mating with outside ornamental articles as the background, the directly projecting light can foster more joyful atmosphere.

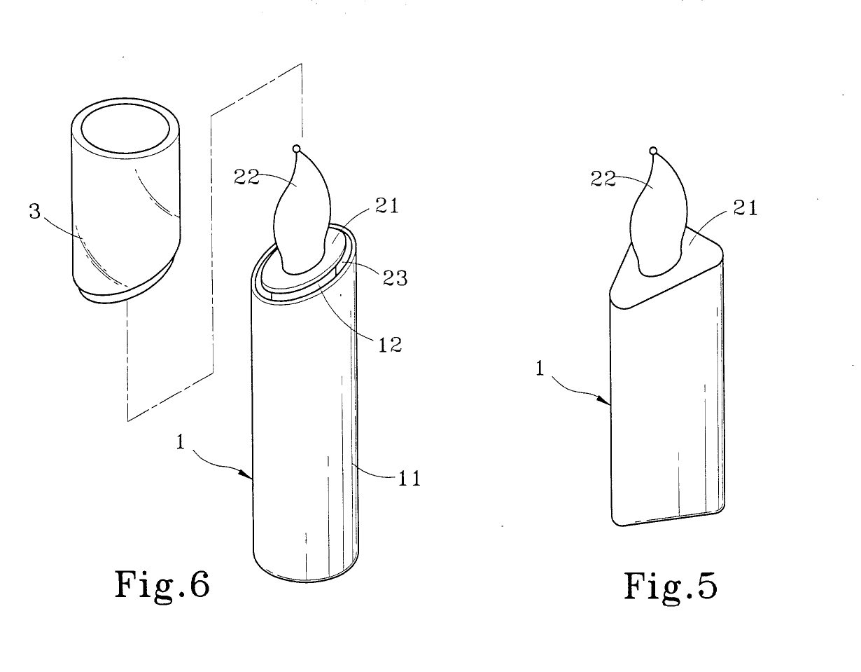

Refer to FIGS. 4 and 5 for a first and a second embodiment of the invention. The bottom of the holder 1 may be mounted onto a clip 4 which may clip a wall or furniture (not shown in the drawings). When the lighting element 22 is energized and illuminates, it can match the exterior environment to give optimal decorative choices. The directly projecting light through the ornamental articles can foster romantic atmosphere of the whole environment. In addition, the holder may be a polygonal strut.

Refer to FIG. 6 for a third embodiment of the invention. The holder 1 includes an outer shell 11 and an inner shell 12 which is fixedly located inside the outer shell 11. The upper end of the inner shell 12 engages with a coupling unit 2 which is extended downwards from the inclined surface 21. There is a fastening section 23 located between the inclined surface 21 and the outer shell 11 to couple with a lamp shade 3. The coupling unit 2 has an upper side engaging with a lighting element 22. When the lighting element 22 is energized, lights emitted from the lighting element 22 pass through the lamp shade 3 and refract in all directions to generate brilliant reflective optical paths thereby to create a pleasant visual effect or produce a greater marginal effect. Moreover, the lamp shade 3 may protect the lighting element 22 from being damaged by external factors. The inclined surface 21 has a greater width than conventional candle lamps, thus the lamp shade 3 and the lighting element 22 are spaced from each other at a greater distance. As a result, the lighting element 22 has more space to refract lights. Lights emitted from the lighting element 22 are refracted repeatedly on the inner wall of the lamp shade 3, and can generate a fuzzy and swaying visual effect. Thus the entire candle lamp emanates a real candle light image and feeling, and can foster a warm and romantic atmosphere.

Moreover, the holder 1 may be formed with a convex surface, a concave surface, a carved out surface. It also may be made transparent, translucent, or with smoke surfaces.

Furthermore, the outer surface of the holder 1 may be formed with different patterns, floral traces and curved lines to allow the light to project the entire holder 1 thereby create a pleasant and amusing visual effect on the public sites or in the house. The holder thus formed provides higher lighting quality with sensuous appealing, and has greater added value.

In addition, the inclined surface 21 may also be formed with different patterns, floral traces and curved lines to allow the light to project through and scatter into people's eyes to formed overlapped and three dimensional images according to parallax principle, and enable people to sense different visual effect and lighting quality. The invention provides a novel sensuous lightly effect not possible for conventional candle lamps, and offers greater marginal effect.

What is claimed is:

1. A candle lamp holder, comprising:
a lighting element; and
a holder having an upper end formed an inclined surface to hold the lighting element.

2. The candle lamp holder of claim 1, wherein the inclined surface and the lighting element are integrally formed or made separately.

3. The candle lamp holder of claim 1, wherein the inclined surface is formed with different patterns, floral traces and curved lines.

4. The candle lamp holder of claim 1, wherein the inclined surface is extended downwards to form a coupling unit.

5. The candle lamp holder of claim 1, wherein the holder has a bottom end attached to a clip.

6. The candle lamp holder of claim 1, wherein the holder and the lighting element are integrally formed.

7. The candle lamp holder of claim 1, wherein the holder includes an outer shell and an inner shell.

8. The candle lamp holder of claim 7, wherein the outer shell and the inner shell are interposed by a fastening section.
